(19) United States
(12) Patent Application Publication
(10) Pub. No.: US 2003/0108666 A1
(43) Pub. Date: Jun. 12, 2003

(54) Method and arrangement for manufacturing coated and glazed paper or board

(76) Inventors: Vilho Nissinen, Numminen (FI); Elias Retulainen, Jyvaskyla (FI); Johan Gron, Espoo (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/239,769

(22) PCT Filed: Mar. 28, 2001
(86) PCT No.: PCT/FI01/00301

(30) Foreign Application Priority Data
Mar. 30, 2000 (FI) 20000734

(51) Int. Cl. B05D 1/12; B05D 3/02

(52) U.S. Cl. 427/180; 118/620; 118/629; 427/475; 427/385.5

(57) ABSTRACT

A method and an assembly is disclosed for manufacturing a web of glazed paper or board so as to produce with a web surface treated with a treatment agent, the method comprising the steps of first producing a base web (10), whereupon in an applicator apparatus to the surface of the web is applied in at least one step at least one kind of a treatment agent. Subsequent to the application of the treatment agent, the web (10) is passed via a dryer. The solids content of the treatment agent to be applied the surface of the web (10) in an applicator apparatus is not less than 80 %, and after the application of the treatment agent, the web (10) is passed via a belt dryer comprising at least one heatable belt (2) in such a manner that the heatable belt comes to face the treated surface of the web (10). Advantageously, the web has a high moisture content prior to the application of the treatment agent.

The present invention relates to a method according to the preamble of claim 1 for manufacturing such an at least one-sidedly treated web, e.g., of a coated paper or board grade, wherein the qualities of the treated surface are at least partially equal to those of a glazed surface.

A plurality of different surface treatment materials is used in the art of coating paper and board webs to improve their qualities. Most common of such treatment agents are sizing compositions that render strength to the base web, and mineral pigments that enhance the printability properties of the sheet. In addition to these, different kinds of polymer coats, among others, are applied to improve the sheet resistance to liquids and gases. Also sizes and pigments may be mixed with various polymers to improve the qualities of the coating mix and the runnability of the web. Certain polymer compounds can be applied to the web surface in melted or monomer form that is set by cooling or via a polymerization reaction. Coating may also be applied as a film. Conventionally, however, the coating composition is formed by a mixture of a number of different components dissolved/slurried in water with a solids content of 5 to 60%. The lowest solids content values can be found in surface sizes and the highest in slurried mineral pigment mixtures that in modem coating formulations and coating techniques may have a solids content even exceeding 70%. Due to constraints set by the physical properties of coating compositions, however, pushing the solids content higher than 40% appears difficult. The greatest problem in the application of high-solids coating mixes is encountered in the rapid increase of viscosity at a high solids content, as well as in the thixotropic and pseudoplastic behavior of the coating mix. Hence, the flowability of these coating compositions is strongly dependent on the shear forces imposed thereon, which means that they are easy to handle in a highly turbulent flow, while in a slow, laminar flow their viscosity increases substantially. Inasmuch the purpose of coating applicator apparatuses is to form a maximally uniform laminar flow to ensure an even profile of the applied coating layer, high-solids coating compositions must be handled in applicators within the rheological region of high viscosity. Therefor, the solids content of water-slurried coating mixes cannot be pushed to the extremes without the penalty of inferior runnability. With an excessively high solids content, the coating mix becomes difficult to manage in the process.

Due to the above-given reasons, coating compositions normally contain a plentiful amount of water that is also partially absorbed by the web. This water applied with the coating mix must also be removed from both the coating layer and the base web. As concurrent coating compositions have a water content of about 40%, the amount of water transferred to the web and into the base sheet is huge. Coating with pigment-containing mixes is conventionally made on a dry, possibly precalendered web, whereby a separate drying step is required to remove water from the applied coat. Evaporation of excess water is energy-consuming and, owing to the large amount of water to be evaporated, the overall energy consumption of drying is high. Dryers require a large footprint and increase the investment costs of the coater. The drying process is difficult to keep under constant control for maximum coat quality and good printability of the coated web. Water penetrating from the coating layer swells the fibers of the base sheet thus causing roughness of the base sheet and the coating layer up to the degree that the fibers of the base sheet especially with thin coating layers begin to stick up from the coating layer. Inasmuch the optical and printing properties of fibers are different from those of the coat, fibers sticking up from the coating layer impair the qualities of the surface subject to improvement by coating. Rewetting and redrying of a base sheet once already dried reduce the strength properties of the sheet. Hence, if good smoothness is required from a web treated with a water-based coating composition, the web must be calendered after coating due to web roughness caused by projecting fibers and other factors. Sizing invokes similar effects as those related to coating with pigment-containing compositions. On the basis of the above, it is obvious that coating a base sheet with a water-based treatment agent leads to a multistep process, wherein both the treatment process and the equipment needed for the treatment become expensive and yet the deterioration of the base sheet properties is a problem.

It is an object of the present invention to provide an entirely new type of method for treating a web of paper or board, in which method both the impact of the water carried by the treatment agent as well as the need for drying energy and equipment can be reduced.

The goal of the invention is achieved by way of applying to the web to be treated a treatment agent whose solids is in excess of 80% and then passing the web into a belt dryer also known in the art as the Condebelt™ dryer.

According to a preferred embodiment of the invention, the treatment agent is applied to a web of a substantially high moisture content.

More specifically, the method according to the invention is characterized by what is stated in the characterizing part of claim 1.

Furthermore, the assembly according to the invention is characterized by what is stated in the characterizing part of claim DD.

The invention offers significant benefits.

As the method is based on the use of a dry treatment agent, the need for drying the web due to the moisture of applied treatment agent is eliminated and, therefor, deterioration of the base sheet qualities due to plural successive wetting and drying steps cannot occur. The base sheet can have a relatively high moisture content, such as is in a web that typically comes directly from the press section to the Condebelt™ dryer, whereby the solids content is about 35 to 55%. Here, the web moisture content is sufficiently high for forming the chemical bonds required by certain treatment agents even if the agent itself is water-free. Hence, treatment agents can readily adhere to the wet web. As the web travels in the Condebelt™ dryer between an impervious heated belt and a water-permeable wire, the removal of moisture takes place via the wire. By applying the treatment agent on the web side facing the belt, moisture is forced to leave the wet web in the opposite direction from the treated surface and, thus, the moisture cannot leave the web via the treated surface, which might deteriorate the coat quality, for instance. The web surface facing the flat belt becomes embossed with the surface pattern of the belt meaning that a belt with a surface polished to a mirror gloss gives the web an extremely smooth surface profile. Respectively, a matte sheet surface can be manufactured using a matte-surfaced belt. This offers the possibility of entirely omitting the finishing calendering of the web. Accordingly, the steps of web coating or surface-sizing and calendering can be performed integrally in one step during drying, thus in principle combining three different treatment steps. Obviously, this approach reduces manufacturing and investment costs. Furthermore, the manufacturing line can be made shorter and energy consumption is cut.

In the following, the invention will be examined in greater detail with the help of exemplifying embodiments and making reference to the appended drawing. FIGURE shows a diagrammatic view of an embodiment according to the invention.

On the right side of the diagram is shown a belt dryer also known as the Condebelt™ dryer, while on the left side is shown an applicator apparatus of a pulverized treatment agent. The belt dryer comprises two opposed steel belts 1, 2 passed over guide rolls 3. About the first belt 1 is first adapted to pass a coarse wire 4 and running thereon, a fine wire 5. These wires 4, 5 are tensioned in a conventional manner by means of rolls 6, 7. The surface of the first belt 1 is kept clean by means of a doctor 8, and the water removal from this coarse wire takes place on a suction box 9. The steel belts 1, 2 are adapted to run in a parallel opposed manner so that their guide rolls 3 are aligned above one another. The coarse wire 4 and the fine wire 5 run in the gap between the steel belts 1, 2, and into the same gap is also passed a web 10 to be treated so that the web 10 is arranged to run pressed between the fine wire 5 and the second steel belt 2. At the ingoing meeting point of the fine wire 7 and the coarse wire 4 is placed an air barrier device 17 serving to prevent air that travels on-the surfaces of the wires from entering the gap between the belts 1 and 2. To the interior side of the loops of the steel belts 1, 2 are adapted means for cooling the first belt 1 and for heating the second belt 2. The heating means comprises a steam chamber 11 placed on the opposite side of the second belt 2 in regard to the web 10. The steam chamber 11 is sealed at its edges by seals 13 and it may be divided by partitions 12 into compartments that equalize and control the distribution of heat applied against the surface of the belt 2. The cooling means comprises a similar chamber 14 equipped with edge seals 15 and partitions 16; the only difference being that water is circulated in said chamber 14. The pressure in the steam chamber may vary in the range of 0.5-5 bar, whereby a higher pressure may be applied to achieve a stronger drying effect due to a higher pressing force and elevated temperature. Obviously, the pressure in the cooling water chamber must be controlled equal to that of the steam chamber.

In the operation of the belt dryer, the web 14 is conventionally passed to the dryer directly from the press section of a paper/boardmaking machine at a solids content of 30-55%, which means that the moisture content of the web is still substantially high. When the web 14 having a high moisture content is passed into the gap between the belts 1, 2, one surface of the web meets the hot belt 2. Herein, water is removed from the web in the direction of the cooler side of the web, that is, toward the cooled surface of the first steel belt 1. Simultaneously, the web is subjected to pressure and its tendency to shrink both laterally and longitudinally is prevented by the applied pressure. The areal pressure also has a great importance in terms of the web surface quality and strength properties. As the conformability of wet fibers at this stage is good, the fibers can be taken above their glass transition temperature with the help of the pressure and elevated temperature applied to the fibers in the gap between the belts 1, 2, whereby deformation of fibers thus attained remains permanent. Obviously, the conformability behavior is dependent on the type of fibers in the web. An essential target is to keep the temperature of the fiber network in the formed web above 120° C. inasmuch this temperature is the softening temperature of lignin-bonds in the presence of water. Under these conditions, the fibers become very elastic, whereby they can be intensively pressed and deformed against each other so as to establish a plentiful number of interfiber bonds. The great number of bonds between fibers is a crucial factor rendering the web a good strength. Treatment on a belt dryer has been found to give a web of paper or board superior strength qualities over those of a web dried on a cylinder dryer.

The moisture content of the paper or paperboard web entering the belt dryer can be relatively high, but when necessary intermediate dryers can be used after the press section to elevate the solids content of the web. However, to keep the strength qualities of the web at a high level, it must be ensured that the web contains a sufficient amount of water for deformation of fibers. This means that the solids content of the web advantageously should not be greater than 60%. Reduced gloss is the most apparent change in the finished web if the web is allowed to enter the dryer at a too low moisture content. On the outgoing side, the moisture of the web leaving the dryer may vary between a product dried to about 70-80% solids and a finished-dry product. While drying the product even more imparts a higher strength, the drying effect can be increased only up to the limit where the web still can retain the residual amount of steam when the web leaves the belt dryer. If the solids content and applied steam pressure exceed a given limit in the web leaving the pressure of the belt dryer, a risk of web delamination arises. The combination of a suitable solids content and drying capacity must be selected for each type of product separately. It must be noted that the above discussion on the constraints of moisture and solids content values is related to the qualities of the basic fiber network in the web.

Obviously, the contribution of solids in the treatment agent on the overall solids content of the product merits an individual treatise.

The structure of the belt dryer may be varied from that used in the exemplifying embodiment. This type of dryer is specifically characterized by having the web being treated arranged to pass between a heated wire and a cooled wire, whereby water removal takes place in the opposite direction from the heated web surface, while the entire web is simultaneously running under a compressive force. One embodiment of such a belt dryer is described in patent publication FI 96,790 (corresponding to U.S. Pat. No. 0,000,000).

An applicator apparatus is located in front of the belt dryer, upstream thereof in the travel direction of the web, for applying a pulverized treatment agent to the web surface. In an applicator type suited for implementing the concept of the invention, the treatment agent is adhered to the web by electric forces. The web 10 is adapted to pass over a conducting belt 10 that runs guided by rolls 18. To the opposite side of the web in regard to the belt is placed an array of electrodes 20 that are taken to a high potential by means of a power supply 21. The conducting belt 19 is either taken to the ground potential or to any potential below that of the electrodes 20. Operating in conjunction with the electrodes 20 is placed a feed chamber 23 for distribution of the pulverized treatment agent into the gap between the tips 20 of the electrodes 20 and the web 10. As the electric field 22 exiting from the tip of each one of the electrodes 20 forms a flux tube of a conical shape, the number and location of electrode tips must be configured so that the conical flux tubes leaving the staggered electrode tips provide a uniform field on the surface of the conducting belt acting as the counterelectrode. The applied electrode voltage is dependent on the distance between the conducting belt 19 and the electrode tips 20 that may be varied from 2 mm to 2 m; however, to keep the space requirements of the pulverized treatment agent distribution equipment 23 within practicable limits, an interelectrode distance range of 100-1000 mm is favored. While a large interelectrode distance as such does not impair the function of the apparatus, it increases the external dimensions of the system. When using the above-mentioned design value of the practicably most preferred process, the voltage applied between the opposed electrodes is typically set in the range 80-160 kV, but may be varied as widely as from 30 kV to 1000 kV. The counterelectrode may be run positive or negative, and the electrode tips may respectively be connected to the negative or positive terminal of the power supply.

The applicator apparatus described herein is based on the so-called ion-blast technique. In this technique a strong electric field is formed between one or typically a plurality of pointed electrodes and one planar counterelectrode. The tip of the pointed electrode emits a corona discharge that charges particles located in the vicinity of the electrode tip thus causing the generation of ions in the electronegative gaseous medium. The ions migrate along the field lines extending between the electrode and the counterelectrode which is taken to the ground potential or to any lower potential, whereby the ions adhere to particles they meet on their travel. The electric field transports the charged particles toward the ground-potential electrode, where they adhere to the substrate by electric and mechanical forces. If the distance between the opposed electrodes is large and the applied voltage is high (more than 50 kV), a gas flow is established between the opposed electrodes that can mechanically transport the charged particles in the interelectrode gap toward the ground-potential electrode. This flow is known as ion blast. In the ion-blast phenomenon, the electric field exiting from the tip of the electrode forms a conical field pattern in which the ionized gas and charged particles move. Ion blast can transport both solid particles and liquid droplets.

According to the present invention, a treatment agent is applied to the web to be treated at a very high solids content in regard to the solids content of conventional water based treatment agent formulations. Most advantageously, the treatment agent is applied to a web having a high moisture content and, hence, a low solids content, typically smaller than 60%. In the exemplifying embodiment illustrated in the diagram, the treatment agent is applied in a pulverized or dust form, whereby its moisture content is practically zero. The treatment agent may contain a binder meltable or softeneable under heat, whereby the adherence of the composition to the web takes place under contact with the hot steel belt in the belt dryer. The treatment agent may be applied directly to the web surface, as is the case in the exemplifying embodiment, or to the surface of the belt that next meets the surface of the web. If the treatment agent is applied to a moist surface of the web, the binder may be redundant with the provision that a pigment used is capable of adhering to the web surface by way of hydrogen bonds, for instance. The treatment agent rendering the qualities proper for the web surface may be applied separately and the binder even preceding the coating composition, whereby a more homogeneous layer of the treatment agent can be produced onto the web surface. If the treatment agent is to be applied to a dry or almost dry web surface, the web can be slightly wetted in order to promote the adherence of the treatment agent. The number of treatment agent application steps may be greater than one in order to make a multilayer coat.

By virtue of the method according to the invention, a web can be treated by all conventional treatment agents, such as calcium carbonate, PCC, kaolin or other pigments, CMC or starch and polymers. Advantageously, polymers are also used as binders. The invention makes the handling of treatment agents easier in the paper mill inasmuch the agents need not be slurried in water, which is an energy-intensive operation. In fact, the web treatment method according to the invention is the more cost-effective the lower the moisture content of the treatment agent to be applied, particularly in the case that the treatment agent is to be applied to a web of a low solids content. At any rate, the solids of the treatment agent should be at least 80%, advantageously even higher. Given the fact that even so-called dry pulverized materials always contain a certain amount of water, typically 2 to 4%, the preferred solids content of the treatment agent is greater than 90%, advantageously in the range of 95-100%, which is the moisture content of such agents under normal storage conditions. If the solids fall close to 80%, certain materials may become pasty and thus difficult to handle, which does not necessarily exclude the use of these materials in the invention with the provision that suitable techniques are used for applying the agents on the web surface. To the spirit of the invention, it is essential that the treatment agent shall not import a large amount of water onto the web surface that must be removed during drying.

One of the problems to be solved in a practical implementation of the invention is the adherence of the treatment agent to the heated steel belt. This subject was investigated in a test series focused on the suitability of the treatment method according to the invention to the manufacture of coated paper. The test was carried out using a static test dryer, wherein the test sheets were compressed between a metal plate and a wire in the same fashion as is performed in a continuously running belt dryer. The sheets were wetted with steam to an initial moisture content of 15 to 20%. The test run was performed using three different pigments named as Polymer #1, code number 990625.1, Polymer #2 with hollow-core PCC, code number 990705.8 and Polymer #3 with solid-core PCC, code number 990705.11. The precise composition of the pigment grades is not described herein inasmuch the primary goal of the test was defined as to study the effects of varying web treatment parameters and agents compositions on the outcome of the test.

Certain findings were particularly favorable among the test data. According to this test series, the quality of treatment is improved by following changes in the process parameters: elevation of dryer pressure, a longer retention time under pressure and wetting of the web surface. In fact, the wetting of web surface after coat application makes the present method different from conventional calendering, wherein wetting is not used or the degree of wetting after coat application is at least smaller. Wetting serves to improve the heat-pipe effect that in turn improves the qualities of the web surface and, in combination with the added moisture, enhances the adherence of the coat to the base sheet. As the coat was found in several tests to readily stick to the upper steel plate, certain ones of the tests were carried out using a polytetrafluorethylene film between the coated surface of the paper web and the pressing steel platen. Herein, the coat appeared to separate readily from the protective film, which urges the use of suitable covering, at least in conjunction with the major types of concurrent coating compositions, on the face of the steel belt of belt dryer facing the web surface. Examples of possible covering materials are PTFE and other high-temperature polymer coverings, as well as coverings applied using chemical and ceramic technologies. The chief qualities required from such a covering are a sufficiently long life at an elevated temperature and poor adherence to other materials.

The best test results were obtained from samples nos. 10, 12, 14, 15 and 22. Of these, sample nos. 10 and 12 were produced using the same coating pigment composition, whereby a higher gloss was measured for sample no. 12, obviously resulting from the applied wetting. The pigment composition used for sample nos. 14, 15 and 22 did not give as high a gloss, but the adherence of the coat pigment to the web surface was good. Accordingly, the chances of finding practicable production parameters for use of these pigment compositions seem promising. The pigment compositions used in sample nos. 5, 6, 7, 13, 20 and 23 did not give as good results in this test series, which means that this composition is less suitable for use in the coating method according to the invention. The results of the test series are listed in Table 1 below.

TABLE 1
Results of test series

| Sample | T | p | | Wet- | PTFE | |
|---|---|---|---|---|---|---|
| no. | [° C.] | [bar] | t [s] | ing | covering | Sample evaluation |
| 1 | 170 | 1 | 1 | no | no | Smooth surface, adherence of coating to top |
| | | | | | | pressing plate, dull gloss. |
| 2 | 170 | 1 | 3 | no | yes | Dull gloss, coating separates. |
| 3 | 170 | 1 | 5 | no | yes | Dull gloss, coating separates. |
| 4 | 170 | 1 | 5 | no | no | Coating adheres to top pressing plate. |
| 5 | 170 | 1 | 0,8 | no | yes | Imperfect adherence, separation of coating. |
| 6 | 170 | 1 | 10 | no | yes | Imperfect adherence, separation of coating. |
| 7 | 170 | 1 | 10 | no | no | Imperfect adherence, separation of coating. |
| 8 | 170 | 1 | 10 | no | no | Imperfect adherence, separation of coating. |
| 9 | 170 | 1 | 10 | no | yes | Imperfect adherence, separation of coating. |
| 10 | 170 | 10 | 2 | no | yes | Smooth surface, dull gloss, some adherence |
| | | | | | | of coating. |
| 11 | 170 | 10 | 2 | no | no | Adherence to hot pressing plate, good |
| | | | | | | adherence of coating to base sheet. |
| 12 | 170 | 10 | 2 | yes | yes | Good adherence and no separation of |
| | | | | | | coating, good gloss. |
| 13 | 170 | 10 | 2 | yes | yes | Medium-glossy surface, minor detachment of |
| | | | | | | coating. |
| 14 | 170 | 10 | 2 | yes | yes | Medium-glossy surface, good adherence of |
| | | | | | | coating. |
| 15 | 170 | 2 | 6 | yes | yes | Dull gloss, good adherence of coating. |
| 16 | 170 | 2 | 6 | no | yes | Dull gloss, no detachment of coating. |
| 17 | 120 | 2 | 2 | no | yes | Dull gloss, detachment of coating. |
| 18 | 120 | 2 | 8 | yes | yes | Dull gloss, some detachment of coating. |
| 19 | 120 | 2 | 8 | yes | yes | Good gloss, some detachment of coating. |
| 20 | 120 | 2 | 8 | yes | yes | Dull gloss, some detachment of coating. |
| 21 | 120 | 2 | 8 | yes | yes | Dull gloss, some detachment of coating. |
| 22 | 120 | 10 | 8 | yes | yes | Dull gloss, good adherence of coating. |
| 23 | 120 | 10 | 8 | yes | yes | Dull gloss, good adherence of coating. |
| 24 | 120 | 2 | 8 | yes | yes | Dull gloss, some detachment of coating. |
| 25 | 120 | 2 | 8 | yes | yes | Dull gloss, some detachment of coating. |

The test series was carried out using the following pigment compositions:

Polymer #1, code 990625.1 for sample nos. 1, 2, 3, 4, 10, 11, 12, 17, 18, 19

Polymer #2 with hollow-core PCC, code 990705.8 for sample nos. 5, 6, 7, 13, 20, 23

Polymer #3 with solid core PCC, code 990705.11 for sample nos. 8, 9, 14, 15, 16, 21, , 24, 25

On the basis of the test results, the coating method according to the invention can be arranged to operate under process conditions, wherein a web surface of an extremely high quality can be attained by way of matching the process variables to the properties of the treatment agent being applied. A further finding from the tests was that in the belt dryer it is necessary to cover the surface of the belt facing the treated surface of the web either with an antistick material or the web itself must have a surface layer of such an antistick material.

Without departing from the spirit and scope of the invention, also embodiments different from those described above may be contemplated.

The belts of the belt dryer may also be made from other materials than steel. However, the characterizing properties of steel such as good strength and thermal conductivity, combined with easy processability and low price make it a material of first choice. Nevertheless, the belt must be surfaced with an antistick material such as a polymer layer or a ceramic covering or a chemically produced surface layer. The covering should feature antistick properties against other materials and a good thermal stability. A plurality of such coverings are known in the art, the most common of them being PTFE-based surface coverings.

The treatment agent can be applied to the web surface in plural ways. In addition to the above-described electrostatic application/adherence technique, the treatment agent can be applied in milled or pulverized form directly onto the web surface from spray or curtain applicator, for instance. If the treatment agent is in a dry dust or pulverized form, it can be charged by electrical means and, respectively, by taking the surface to be treated to an opposite potential, the powder can be made to adhere to the thus charged surface. The charged particles of the powder may be applied directly to the web surface or, e.g., via a transfer roll or belt by charging the belt, then adhering the powder to this transfer means and finally transferring the powder to the web surface by way of compressing the transfer means against the web. Besides being suitable for the treatment of a wet web, the invention is also applicable to the coating, surface-sizing and other treatment of a dry web. The above discussion is related to one-sided treatment of a web only. As the present invention finds its principal applications in the manufacture of one-sidedly treated products, a two-sided treatment by a pigment-containing composition, for instance, requires a treatment line having two sequences of the above-described steps operating one after another. The treatment agent application step may be preceded or followed by a wetting step of the web or, alternatively, the web can be subjected to drying prior to taking the same into the belt dryer.

What is claimed is:

1. Method for manufacturing a web of glazed paper or board so as to produce a web surface treated with a treatment agent, the method comprising the steps of
producing a base web (10),
passing the base web (10) to at least one applicator apparatus, wherein to the surface of the web is applied in at least one step at least one kind of a treatment agent, and
passing the web (10) in at least one step via a dryer,
characterized in that
to the surface of the web (10) is applied in at least one step a treatment agent having a solids content not less than 80%, and
after the application of said treatment agent, the web (10) is passed via a belt dryer comprising at least one heatable belt (2) in such a manner that the heatable belt comes to face the treated surface of the web (10).

2. Method according to claim 1, characterized in that the solids content of the web prior to its entry into the belt dryer is not greater than 60%.

3. Method according to claim 1, characterized in that the web (10) is wetted in at least one step prior to its entry into the belt dryer.

4. Method according to claim 1, characterized in that at least one of the treatment agents used in the method contains a heat-meltable binder.

5. Method according to claim 1 or 4, characterized in that binder is first applied to the web surface, followed by the application of at least one kind of a treatment agent.

6. Method according to claim 1, characterized in that at least one kind of a treatment agent is applied in pulverized form to the web surface and the adherence of the pulverized agent to the web is implemented by electrostatic means.

7. Method according to claim 1 or 6, characterized in that at least one kind of a treatment agent is first applied to the surface of a transfer means such as a belt or roll, wherefrom the treatment agent is transferred to the web.

8. Method according to claim 7, characterized in that a treatment agent is applied to the surface of a belt (2) of the belt dryer facing the web (10).

9. Assembly for manufacturing a web of glazed paper or board so as to produce a web surface treated with a treatment agent, the assembly comprising
at least one applicator apparatus for applying a treatment agent to at least one surface of the web, and
at least one dryer for treating the web (10),
characterized in that
the applicator apparatus adapted to operate in front of the dryer, upstream in the travel direction of the web, and the applicator apparatus being capable of applying to the web surface a treatment agent having a solids content not less than 80%, and
the dryer is a belt dryer comprising at least one heatable belt (2) against which the surface of the web (10) treated with the treatment agent can be pressed.

10. Assembly according to claim 10, characterized in that at least one of the belts (2) of the belt dryer intended to face the surface of the web (10) is covered with an antistick material.

11. Assembly according to claim 10, characterized in that said antistick covering material is a polymer layer or a chemically produced surface layer or a ceramic covering, advantageously a PTFE-based surface covering.

12. Assembly according to claim 9, characterized in that therein at least one applicator apparatus comprises
at least one conducting surface (19) along which a web (10) can be adapted to run,
at least one pointed electrode (20) directed toward the conducting surface (19),
a power supply (21) for establishing a potential difference between said conducting surface (19) and said electrode, and
means (23) for feeding a treatment agent into the gap between said electrode (20) and said conducting surface (19) for passing the treatment agent into an adhering contact with the surface of the web (10) running on said conducting surface.

13. Assembly according to claim 9, characterized in that said applicator apparatus comprises means for charging the surface of the web (10) and means for passing particles carrying an opposite charge to the thus charged surface of the web (10).

14. Assembly according to claim 9, characterized in that said applicator apparatus comprises means for applying a treatment agent to the surface of a belt (2) adapted to run against the surface of the web (10).
